(19) United States
(12) Patent Application Publication
(10) Pub. No.: US 2008/0273027 A1
(43) Pub. Date: Nov. 6, 2008

(54) Methods and Devices for Generating and Viewing a Planar Image Which Is Perceived as Three Dimensional

(76) Inventor: Eric Feremans, Lauwe (Rekkem) (BE)

Correspondence Address: BROWDY AND NEIMARK, P.L.L.C.;624 NINTH STREET, NW, SUITE 300, WASHINGTON, DC, 20001-5303, US

(21) Appl. No.: 11/596,184

(22) PCT Filed: May 12, 2004
(86) PCT No.: PCT/BE04/00071

§ 371 Date: Jul. 14, 2008

(51) Int. Cl. H04N 13/00

(52) U.S. Cl. 345/419

(57) ABSTRACT

A method for generating a planar image which is provided for being perceived by humans as three dimensional, the method comprising the step of generating at least two overlapping portions of planar visual information of which first portion comprises an original planar image and a second portion a diffused image which is generated from the original image by diffusion to a predetermined extent, chosen for stimulating human depth perception. An optical element for generating a planar image which is perceived by humans as three dimensional, the optical element being partly transparent for passing an original planar image and having a predetermined diffusion pattern for generating a diffused image from the original planar image, the predetermined diffusion pattern being chosen for stimulating human depth perception.

The present invention relates to a method for generating a planar image which is provided for being perceived by humans as three dimensional according to the preamble of the first claim. The invention further relates to algorithms implementing the method stored on a data carrier, optical elements for generating three dimensionally perceived images, devices for recording visual information (photo or film cameras and the like) and devices for displaying visual information (televisions, computer displays, LCDs or other screens, devices for projecting still or moving images or other displaying devices).

Many methods and devices for generating three dimensional images, i.e. planar images which are perceived by humans as three dimensional images, are known. Most of the known methods make use of the principle of binocular depth perception, also known as binocular stereoscopy. This principle of creating a three dimensional image is based on creating two slightly different planar images, one for each eye, which are by fusion in the human brain interpreted as one three dimensional image. In this way, the effect is simulated that our eyes see two slightly different images as a result of their position. These “binocular” methods and devices have the disadvantage that creating the images is relatively complex, since each time two images have to be generated, and also that special means are required, such as for example a special monitor or filter glasses or other, for getting the correct image to the eye it is intended for.

This invention mainly deals with monocular depth perception, i.e. the depth perception which can already be derived from the viewing information captured by each individual eye, which could also be termed monocular stereoscopy. However, the invention can also be applied in combination with binocular stereoscopy.

From WO-A-98/48381 a method for enhancing depth effect in a planar image is known. This method integrates one or more monocular cues into the flat image for achieving an enhanced depth effect. A monocular cue is information which is used by the human brain for interpreting visual information supplied by one eye and adding depth to it. The monocular cues comprise a.o. occlusion (one partly object covering another), blur (further objects are less sharp), brightness (further objects are less bright) and shading. One or more of these monocular cues are applied to bring forward an object of interest, which is selected in the flat image, and to move other objects further back.

The method known from WO-A-98/48381 however has the disadvantage that the success of enhancing depth effect depends on the content of the image. The planar image first has to be interpreted for determining an object of interest. This makes the method of WO-A-98/48381 relatively complex.

It is an aim of the present invention to provide a simpler method for generating a planar image which is provided for being perceived by humans as three dimensional.

This aim is achieved according to the invention with the method comprising the steps of the characterising part of the first claim.

As used herein, the wording “planar image” is to be interpreted in its broadest sense, including a planar image as such (e.g. a photograph, an image projected onto a flat or bent screen or the like) and electronic data or photographic material by means of which a planar image can be generated on a screen. The wording is furthermore to be interpreted as including still images, e.g. photographs, as well as moving images, e.g. films.

As used herein, the term “transparent” is intended to mean transparent, translucent or more generally allowing light to shine through in a substantially undisturbed way.

According to the invention, planar visual information is generated which comprises at least two overlapping portions. These portions are generated in such a way that their combination, i.e. the simultaneous viewing by humans, is provided to lead to a three dimensional interpretation of the visual information. A first portion of the visual information comprises an original planar image and a second portion comprises a diffused image which is generated from the original planar image by diffusion. The diffused image is generated by diffusing the original image to a predetermined extent, such that it stimulates human depth perception upon viewing the original image and the diffused image simultaneously. In other words, according to the invention the diffused image which is generated from the original image by diffusion acts as a depth perception stimulating factor, which is added to the original image.

The diffused image and the combination of the diffused image with the original image can be generated in many ways, as will appear from the following. In all embodiments however, there is one common principle: that the human brain is provided with visual information which is composed of an original planar image and a diffused image overlapping the original image, their combination or fusion leading to a stimulation of depth perception. The term “overlapping” is here intended to also include the overlapping which occurs in the human brain, when each eye is provided with a different image but the two are fused in the brain.

With the method of the invention, the factor which stimulates human depth perception, i.e. the diffused image generated from the original planar image, can be generated independently from the content of the image, i.e. independently from what is actually shown. As a result, the step of interpreting the planar image before applying modifications to it can be avoided and the method of the invention can be simplified with respect to the prior art.

In the prior art method, the ways in which depth effect is enhanced all actually change the content of the image, for example by enlarging or highlighting an object of interest and blurring or darkening objects of disinterest. This can lead to an undesirable distortion of the image. In the case of the invention, one can avoid tampering with the content of the image, since the depth perception is triggered by an object-independent mechanism. As a result, the method of the invention makes it possible to generate images of higher quality.

Tests have shown that the quality of the image which can be achieved with the method of the invention can indeed be very high, even though one would expect that by adding the diffusion to the original image, the total image would deteriorate. The reason is that the original image is passed on to the viewer, along with a depth perception stimulating factor, namely the diffused image which is generated from the original image but which does substantially not deteriorate the image. In fact, further tests have shown that with the method of the invention the sharpness of an original planar image can even be enhanced, i.e. that the diffused image not only acts as a depth perception stimulating factor but also as a sharpening factor. By the diffusion, lines and pixels of for example television screens or computer monitors become less visible, so that the resolution of the image is in fact enhanced. As a result, three dimensionally perceived images of surprisingly high quality can be achieved with the method of the invention.

Furthermore, with the method of the invention, the human depth perception is triggered by means of a principle which is different from the “binocular” depth perception techniques. As a result, the need to create one image for each eye and also the need for special means for getting the correct image to the intended eye can be avoided.

The extent of diffusion is preferably subliminal. This means that the diffusion preferably remains sub-conscious to humans, i.e. that the diffusion itself is not consciously perceived, while its depth perception stimulating effect is perceived. Subliminal perception occurs whenever stimuli presented below the threshold or limen for awareness are found to influence thoughts, feelings, or actions. The term subliminal perception was originally used to describe situations in which weak stimuli were perceived without awareness. In recent years, the term has been applied more generally to describe any situation in which unnoticed stimuli are perceived. In other words, the effect which is achievable by means of the invention is a psycho-optical effect which avoids actual distortion of the image.

In a preferred embodiment of the method of the invention, the diffused image is generated by means of one or more transparent optical elements having a predetermined diffusion pattern with parts of different refractive indices. On the one hand, each optical element is transparent for passing the original image. On the other hand, the diffusion pattern of each optical element diffuses the light coming from the original image into the diffused image. As before, the diffusion pattern is chosen such that the diffusion occurs to a given, preferably subliminal extent suitable for stimulating human depth perception. The result is a mixture of the original image and the diffused image, which is provided for being perceived as a three-dimensional image.

The diffusion pattern can for example be formed by dots or lines or other patterns which are printed on the optical element and which deflect light coming from the original image in different directions, thereby generating the diffused image. The pattern can be regular or random. In the case the pattern is composed of dots, these are preferably of a predetermined size and are spread in a predetermined dot density, such that the dots are substantially invisible to the human eye (i.e. the diffusion is subliminal). Similarly in the case of lines, the lines preferably have a predetermined width and a predetermined spacing, such that the lines are substantially invisible to the human eye. The diffusion pattern may otherwise be provided on the optical element by means of surface irregularities such as protrusions, recesses, corrugations, indents or the like, by particles within the optical element or by other light diffusing means known to the person skilled in the art. In general, the diffusion pattern can be compared with a plurality of minuscule lenses spread over the optical element, each minuscule lens having its own focal distance, which explains why the image can be provided with depth as well as with enhanced sharpness.

A preferred embodiment of the transparent optical element according to the invention has a varying density of the light diffusing means (dots, lines, surface irregularities etc.) of the diffusion pattern. In this embodiment, the areas of higher density will diffuse the incoming light to a larger extent than the areas of lower density. One example is an optical element with increasing density of the light diffusing means from the centre of the element towards its outer rim, which we will here call a “converging” optical element. Another example is an optical element with decreasing density of from the centre towards the outer rim, which we will here call a “diverging” optical element. The invention is however not limited to “converging” and “diverging” elements: other variances of the density of light diffusing means are possible, depending on the application for which the optical element is intended. Furthermore, the diffusion may also be varied by colour of the light. The variance of the density may be linear, but may also have another gradient, such as for example according to a complex function which corresponds to Fresnel values, which may optimise the diffusion pattern. A few optical elements may also be combined for reaching an optimal depth effect: for example by placing first a “diverging” element and next a “converging” element, a combination is realised which operates analogously to a collimating lens, but with which the image can be viewed from different distances and from different viewing angles substantially without losing the depth effect.

In another preferred embodiment of the method of the invention, the diffused image is generated by means of a sequence of transparent elements with partial, preferably subliminal reflectivity, for example glass plates or lenses or other elements. By the sequence of elements, the light is reflected from one element to the previous element, which in turn reflects it towards the one element, which in turn passes the major part of the light and so on. Since reflection is not perfect, again a diffused image is generated from and added to the original image. This embodiment furthermore has the advantage that the viewer is provided with a plurality of images on different levels, namely the reflections on each glass plate, so that depth is also generated into the image.

In another preferred embodiment of the method of the invention, the diffused image is generated directly into the original planar image in the following manner. First, the original image is split by colour division into at least two sub-images. Then, a predetermined modification is applied to at least one of the sub-images. Finally, the sub-images are reunited to a modified planar image. The predetermined modification is chosen such that the modified planar image in fact comprises the original image and the desired diffused image generated from this image. In other words, the predetermined modification is chosen for stimulating human depth perception.

Since in many cases, such as for example television screens, images are projected by mixing sub-images in three primary colours, for example a red, a green and a blue image, this second embodiment of the invention is easily applicable to a wide variety of applications. The predetermined modification may for example be the shifting of one sub-image in one direction and another in the opposite direction over the same predetermined distance, or shifting each pixel of one sub-image in one direction over a random distance within a predetermined range and each pixel of another sub-image in the opposite direction over a random distance within the same predetermined range.

In another preferred embodiment of the method of the invention, the diffused image is generated into the original planar image by replacing each pixel of the image with a weighted average of the original pixel and a weighted sum of the surrounding pixels. The weighted average is taken on the basis of a predetermined diffusion parameter, chosen for adding the desired content of diffused image to the original image. The weighted sum may be calculated with random or predetermined coefficients. The diffusion parameter and/or the coefficients may furthermore be varied on the basis of depth information, captured during recording of the image or calculation during creation of for example a cartoon image, or for simulating the use a “converging” or “diverging” optical element as described above. Following tests, this embodiment of the method of the invention has led to surprising results. With this embodiment of the invention it is felt that reality can in fact be approximated, i.e. the resulting planar image is approximately perceived as a window onto a real three-dimensional world.

The method for generating three dimensionally perceived images according to the invention can be applied for displaying images, recording images and also for converting existing images. The method of the invention can be combined with any of the prior art methods for generating three dimensionally perceived images according to the principle of binocular stereoscopy and comprise generating a left eye image for viewing by the left eye only and a right eye image for viewing by the right eye only. Examples of such methods are anaglyphic methods (with colour filters for each eye), interleaved viewing methods (with shutter-glasses in front of the eyes), polarisation methods (with polarisation filters in front of the eyes), dual viewing methods (with a separate screen in front of each eye), LCD with backlighting or other methods.

The invention will be further elucidated by means of the following description and the appended figures.

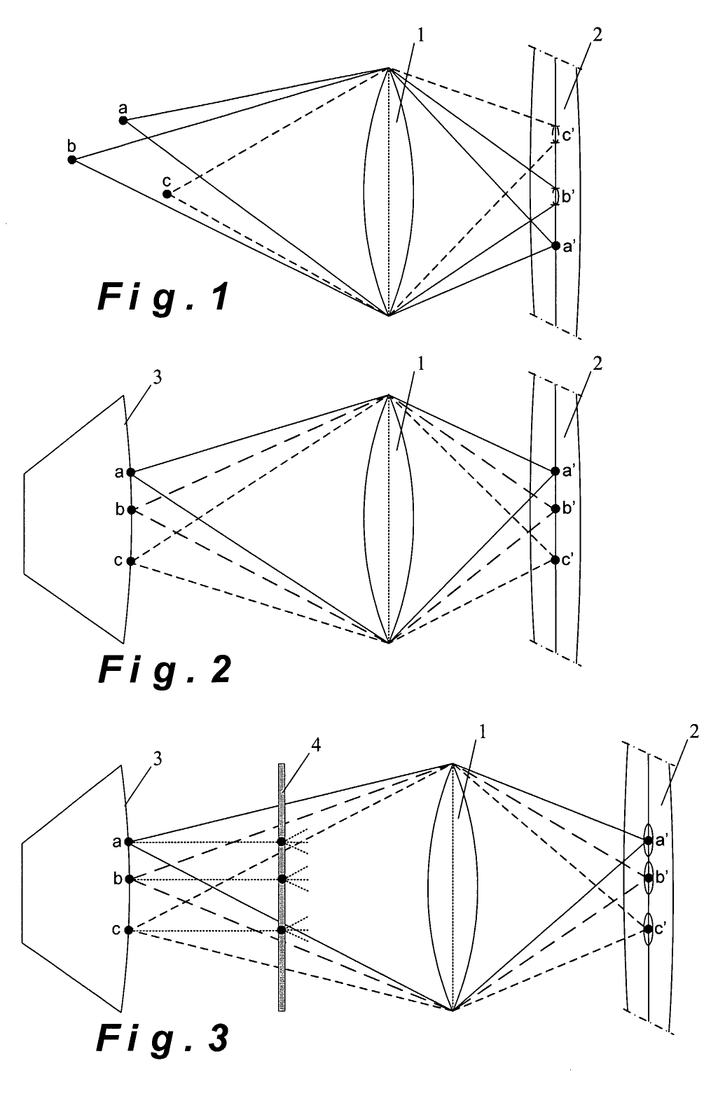

FIGS. 1-3 schematically illustrate the theory underlying the invention.

FIG. 4 shows a first embodiment of the method for recording visual information according to the invention.

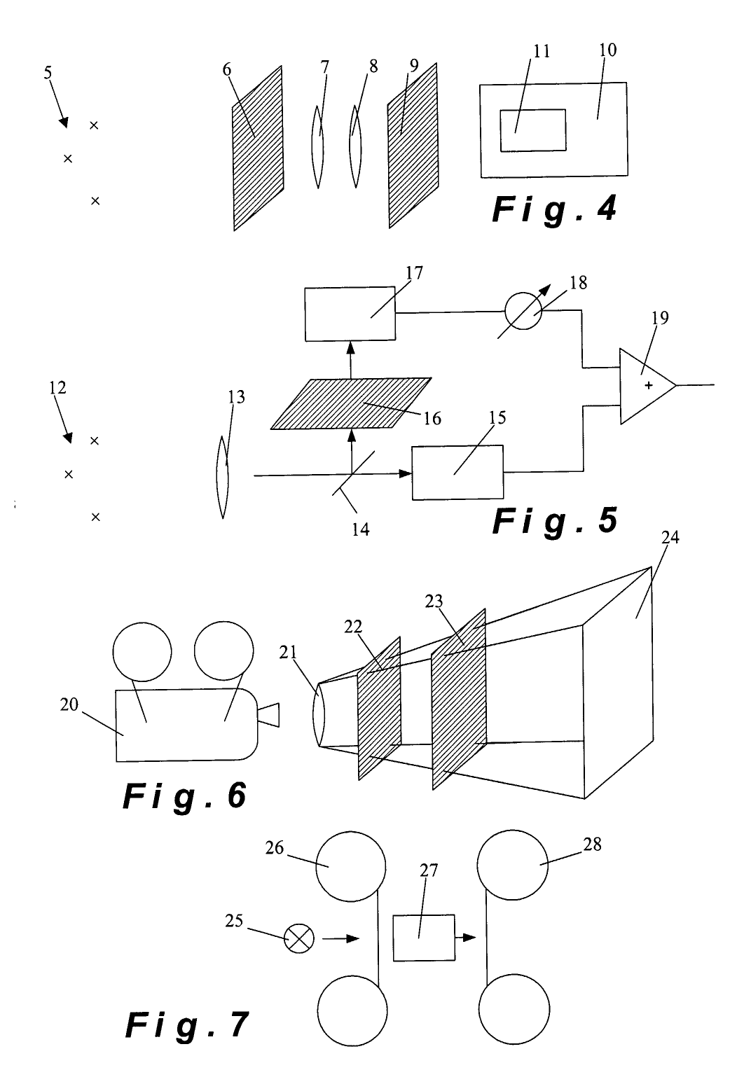

FIG. 5 shows a second embodiment of the method for recording visual information according to the invention.

FIG. 6 shows an embodiment of the method for displaying visual information according to the invention.

FIG. 7 shows an embodiment of the method for converting a regular image into a three dimensionally perceived image according to the invention.

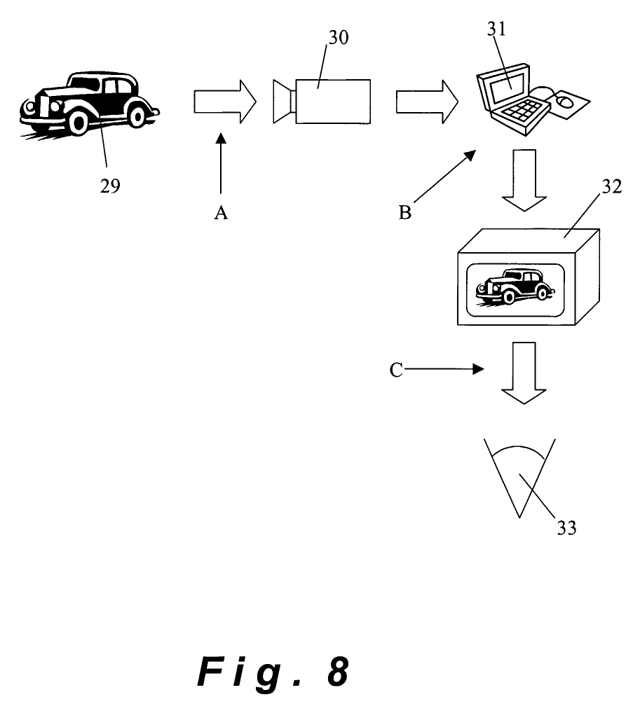

FIG. 8 shows in general the different stages where the method of the invention can be applied.

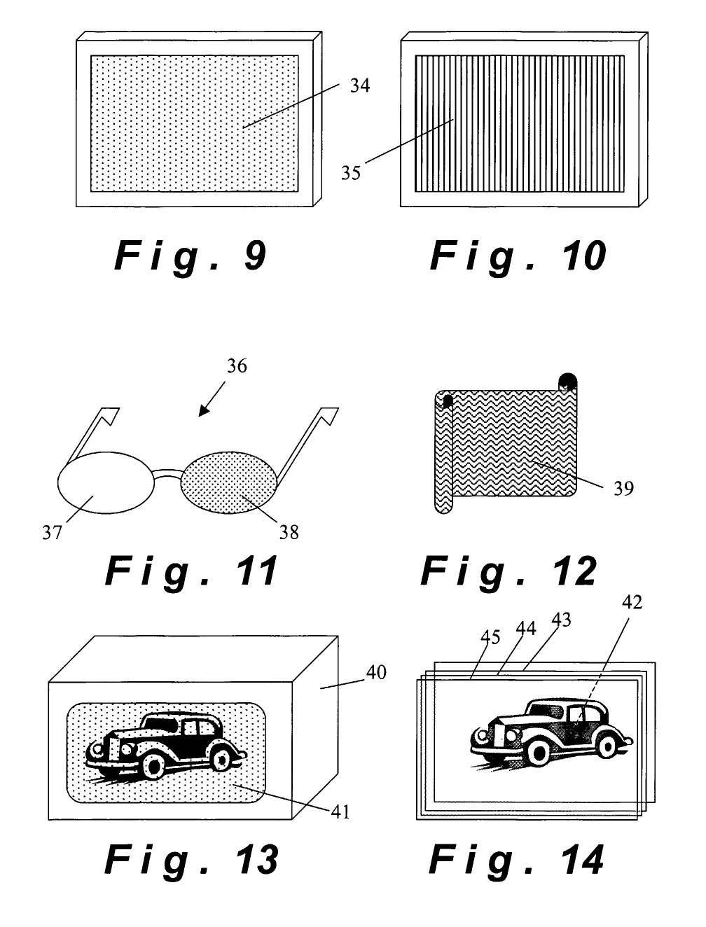

FIGS. 9 and 10 show two embodiments of transparent screens having a diffusion pattern according to the invention.

FIG. 11 shows a pair of glasses, one of which has a diffusion pattern according to the invention.

FIG. 12 shows a transparent stick-on foil having a diffusion pattern according to the invention.

FIG. 13 shows a television screen which is provided with a diffusion pattern according to the invention.

FIG. 14 shows an embodiment of a sequence of transparent optical elements with partial reflectivity according to the invention.

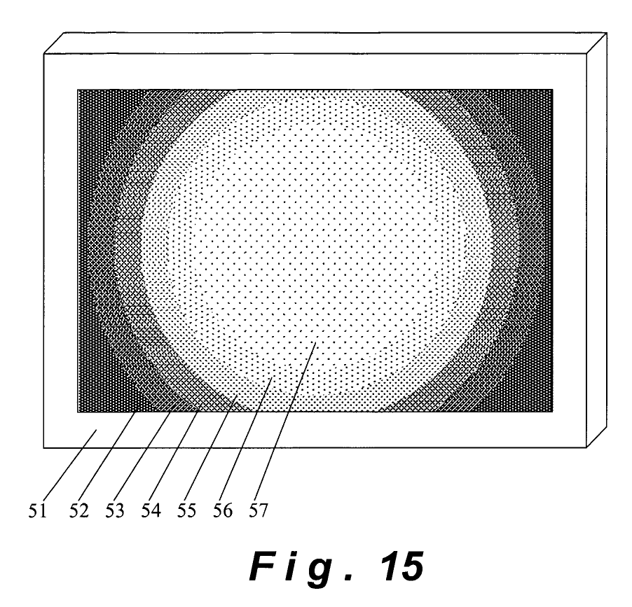

FIG. 15 shows another preferred embodiment of a transparent screen having a diffusion pattern according to the invention.

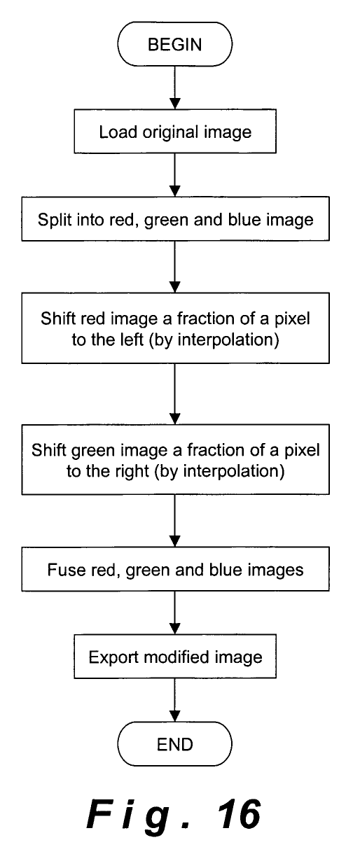

FIG. 16 shows a first embodiment of an algorithm according to the invention for converting a regular planar image into a modified planar image which upon display is provided for being perceived as three dimensional.

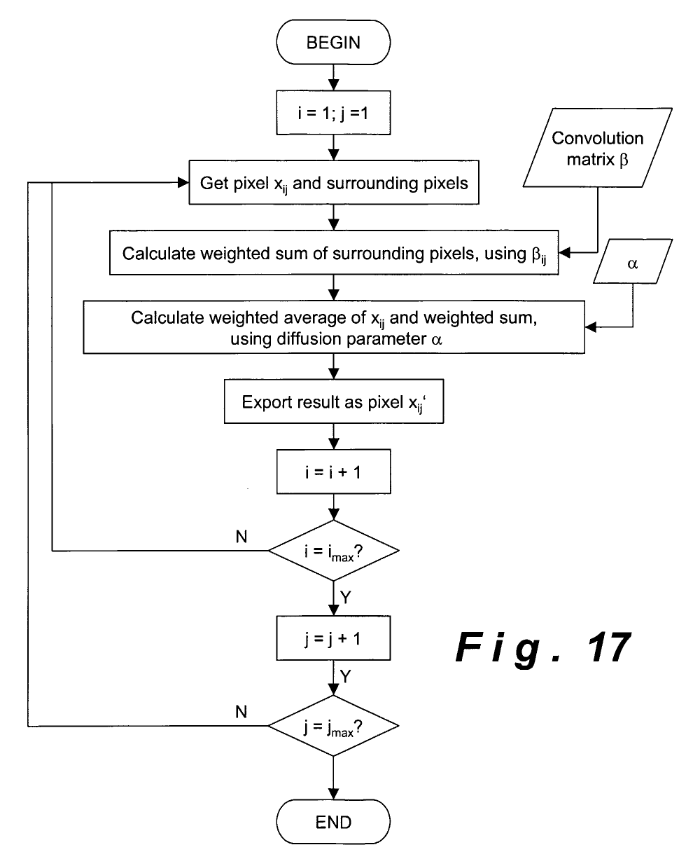

FIG. 17 shows a second embodiment of an algorithm according to the invention for converting a regular planar image into a modified planar image which upon display is provided for being perceived as three dimensional.

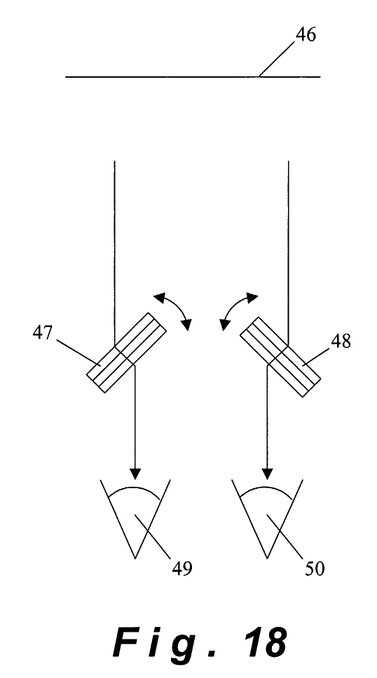

FIG. 18 shows a further application of according to the invention for viewing images with enhanced depth effect.

In order to understand the means of restoring, creating or enhancing depth perception in planar images which are used according to the invention, an explanation of the underlying principles is given.

First of all, it is important to note that the human eye has a lens and projection surface, the retina, which are far from perfect. Therefore, no matter how refined the nowadays available optics, screens, monitors or camera's are, the image is finally viewed with an imperfect eye. This shows that the reason why humans can generally see very well is that a lot of interpretation of imperfect visual information occurs in the brain.

However refined today's visual media are, flat projections are still perceived by humans as “flat”, two-dimensional images. In fact, the flatness of flat images is even increased by today's media: the focus is on making the image as sharp as possible, foreground as well as background. This leads to unrealistic images which are tiring to see with the human eye.

The underlying principle of the invention is in fact the discovery that human depth perception can be triggered by adding a diffused image to the original image. This discovery is surprising and unexpected, since until now the main goal of optical system is and has always been to capture and reproduce an image which is as sharp as possible.

The principle is clarified as follows. In order to perceive a sharp image, three things must happen in the eye:
the image must be reduced in size to fit on the retina;
the scattered light must come together, i.e. focus at the surface of the retina;
the image must be curved to match the curve of the retina.
   To achieve this, the eye is provided with a lens, which is situated between the retina and the cornea, a transparent window at the front of the eye. The lens—which is classified as a “plus” lens because it increases in thickness towards the centre—and the cornea work together for focusing the image on the retina.

It is the assumption of the inventor that, in order to perceive depth in the sharp image, the retina also has to be provided with unfocused visual information, i.e. that part of the image which is not focused by the cornea and lens. This unfocused visual information comprises diffused projections of objects out of focus. It is assumed herein that the human brain uses this unfocused information to interpret the image and for determining the distance of objects. In other words, the unfocused part of an image actually is the part containing the information that produces the perception of depth.

The inventor has discovered that this unfocused information is discarded or weakened to a substantial extent by the known devices for capturing visual information, so that the image which is finally reproduced does not have all the information needed for stimulating three dimensional interpretation of the image. The invention aims to capture this unfocused information, reproduce it or even synthesize it for animation images, which of course have no innate unfocused information.

FIG. 1 shows how objects in reality are viewed by humans. It is assumed that the human eye is focussed on the point a, so that a sharp image a′ of a is projected via the eye lens 1 onto the retina 2. The point b, which is behind a, is focussed behind the retina 2, so that a blurry circle b′ is the projection of b on the retina 2. The point c in front of a is focussed in front of the retina 2, so that a blurry circle c′ is the projection of c on the retina 2. In general, objects in focus lead to a sharp projected image on the retina, whereas objects out of focus lead to a blurry projected image on the retina. In any case, when viewing objects in reality, the eye is provided with sharp and blurry information. It is the assumption of the inventor that this blurry information stimulates the human brain for interpreting the totality of visual information and adding depth information to it.

FIG. 2 shows how a planar image, for example an image on a (slightly bent) television screen 3 is viewed by humans. All points a, b, c are on substantially the same distance from the eye lens, so that when the eye is focussed on the television screen 3 sharp images a′, b′, c′ are projected onto the retina 2 for each of the points a, b, c. This shows that the blurry information, which the inventor assumes to lead to three dimensional perception, is absent upon viewing a planar image. Of course, it occurs that the visual information which is shown on television screens contains blurred or unsharp objects, namely the objects which were out of focus during filming, but according to the inventor the known devices for recording and/or displaying visual information discard or at least weaken the blurry information which is present in reality, so that the reproduced image is perceived as planar.

FIG. 3 shows how one embodiment of the method of the invention intervenes for adding depth to planar images. In the embodiment of the method of the invention shown in FIG. 3, an optical element, namely a transparent screen 4 which is provided with a predetermined light diffusion pattern is placed between the television screen 3 and the eye lens 1. On the one hand, the screen 4 is transparent for passing the original image points a, b, c shown on the television screen 3 to the eye, leading to sharp projections a′, b′, c′. On the other hand, the screen 4 has a diffusion pattern for diffusing the image points a, b, c shown on the television screen 3, which leads to blurry circles around the projections a′, b′, c′ on the retina. As a result, the retina 2 is provided with sharp as well as blurry information as in the case of viewing objects in reality and by interpretation which takes in the human brain, the viewer is able to distinguish which of the points a, b, c is more towards the front and which is more towards the back. In other words, by providing the viewer with a combination of sharp and blurry information, the viewer is able to “see depth” into the visual information. According to the inventor, this combination of sharp and blurry information in fact approximates the way in which objects in reality are viewed and leads to a three dimensional perception of the image shown on the television screen 3.

In FIG. 3, the screen 4 which is used for passing and diffusing the image shown on the television screen 3 can be located anywhere in between the television screen 3 and the eye lens 1. It can for example be a screen, a filter, a lens or other optical element which is placed in front of the television screen or a screen a filter, a lens or optical element which is placed in front of the eye lens. Some examples are shown in FIGS. 9-13.

FIG. 9 shows a first preferred embodiment of a transparent screen 34 for adding a diffused image as depth perception stimulator to an original image, for example a television image. The screen 34 is printed with a regular pattern of minuscule dots. The size of the dots is preferably such, that they are almost invisible to the human eye. For example, their size may be about the size of the pixels on a television screen or even smaller. The space between two neighbouring dots is preferably larger than the size of the dots, so that most of the original image is passed substantially unaltered by the screen 34. In this way, the depth effect of the invention is added to the original image substantially without affecting the content or the quality of the original image.

FIG. 10 shows a second embodiment of a transparent screen 35 for adding a diffused image as depth perception stimulator to an original image. The screen 35 is printed with a regular pattern of vertical lines. Similarly to the screen 34 of FIG. 9, the lines of the screen 35 are preferably substantially invisible to the human eye. In other words, the width of the lines is preferably substantially equal to or smaller than the size of pixels on a television screen and they are preferably spaced more than the width of a pixel from each other.

Instead if the dotted or lined pattern of FIGS. 9 and 10, other patterns can be used, regular or random. The dots or lines or other pattern elements can be printed on the screen or incorporated into the material of the screen. Furthermore, the diffused image as depth perception stimulator may also be achieved by means of other diffusion patterns, such as for example uneven surface patterns, patterns within optical elements of parts having different refractive indices. The depth effect of the invention can be enhanced by using a number of screens 34, or other optical elements in front of each other. One efficient example is the combination of one or more screens 34, 35 with a collimating lens, a Fresnel lens or the like. In some embodiments of the invention, the use of such a lens can be desirable, since the image is then brought directly in front of the eyes of the viewer which can severely enhance the depth effect.

FIG. 11 shows a pair of glasses 36. The right eye glass 37 is a regular, transparent optical element. The left eye glass 38 is an optical element which is provided with a diffusion pattern for stimulating depth perception. As a result, by using the glasses 36 the right eye is provided with an original, substantially unaltered image and the right eye is provided with a mix of the original image and a diffused image generated from the original image. Alternatively, the right eye glass 37 may also be provided with a diffusion pattern, which is then preferably a different pattern from that of the left eye glass 38. In this way, the human brain is not only provided with the combination of the original image and the diffused image, but also with two different images for each eye. It has been found that this can further enhance the depth effect of the invention. The pattern(s) on the glasses 37 and 38 may be any of the above mentioned patterns for stimulating human depth perception.

FIG. 12 shows another embodiment of an optical element according to the invention, more particular a transparent stick-on foil 39 with a diffusion pattern. The foil 39 is a stick-on foil in the sense that it has an adhesive side which is provided for being attached to for example a television screen, a computer display, an LCD or other image displaying device, or to a camera lens or eye glasses or other optical element, or to any object which is to be provided with a diffusion pattern for stimulating human depth perception. The foil 39 of FIG. 12 has a printed pattern of waved lines, which are again preferably substantially invisible to the human eye for maintaining the quality of the image. The foil may however also be provided with any other pattern as mentioned above.

As mentioned above, the screens 34 and 35 and the foil 39 can for example be applied to television or more generally, to means for displaying moving images. They can however also be applied over photographs, paintings or other still images, for adding depth effect.

FIG. 13 shows a television set 40 of which the picture tube screen 41 is provided with a diffusion pattern for stimulating human depth perception. The diffusion pattern of the screen 41 may again be any of the above mentioned patterns for stimulating human depth perception. The pattern may be applied on the screen 41 by for example a surface treatment, by adding minuscule, light diffracting particles to the material of the screen 41 during its production, by attaching a foil 39 or by means of another treatment.

The diffusion pattern on a television screen 41 or other display or optical elements in general may for example also be applied by spraying tiny droplets of a coloured transparent liquid onto the screen 41, such as for example thinned ink, a solution of water paint, a solvent with a colouring agent or other coloured transparent liquid. After the droplets of such a coloured transparent liquid have dried on the screen 41, they leave substantially circular marks of which the colouring is concentrated towards the outside as a result of evaporation along the edges of the droplet (this effect is known as “capillary pull” and has been described by scientists such as Sid Nagel (Ph.D., Princeton, 1974, Stein-Freiler Distinguished Service Prof., Dept. Physics, James Franck Inst., and the College) and Tom Witten (University of Chicago)). Because of the resulting irregular pattern, the occurrence of so-called moiré-patterns on viewing the image through the screen 41 is avoided. In other words, by spraying coloured transparent liquid, a pattern of thin, substantially invisible circular shapes can be formed on the screen 41, so that the quality of the television image is again substantially unaffected. This method can be refined by selective spraying, for example in horizontal or vertical lines or according to more complex geometric shapes, by using a plurality of layers and/or different colours.

Alternative surface treatments for applying a diffusion pattern according to the invention on an optical element are for example: sandblasting patterns into the surface, etching patterns with corrosive products or printing patterns with known printing techniques. In order to obtain the desired pattern, first a photosensitive layer or mask can be applied, irradiated with light and developed, or pre-printed or constructed patterns can be used which are applied with external masks or cliches. A typical example is the sandblasting or etching of UV- or other ancillary lenses for use with cameras or projectors for obtaining diffusion patterns which may be applied on the whole surface or on a part thereof and may optionally be applied according to predetermined designs.

FIG. 14 shows a sequence of transparent screens 43-45 which are also intended for adding a diffused image as depth perception stimulator to an original image 42. The image 42 shown here is a photograph, but it may also be a television image or any other image on any other displaying device. The screens 43-45 are optical elements with partial transparency and partial, preferably subliminal reflectivity, so that the major part of the original image 42 is passed and the diffusion occurs subconsciously to the viewer. By the sequence of screens 43-45, the light is reflected from one screen to the previous screen, which in turn reflects it towards the one screen, which in turn passes the major part of the light and so on. In this way, again a diffused image is added to the original image 42. The number of screens 43-45 with a small percentage reflectivity is at least two, preferably three or four, but may also be more. The screens 43-45 may also be provided as layers of a single, laminated element. The front screen 45 is preferably a non-glare screen, so as to avoid disturbing reflections of objects in front of the screen 45. The sequence of screens 43-45 also leads to an infinity effect (like for example a person standing in between two mirrors facing each other): the viewer sees multiple layers of images and can subconsciously focus on images at different distances, so that the depth effect can be further enhanced.

FIG. 15 shows a further embodiment of a transparent screen 51, in which the density of the diffusing elements (dots or lines etc.) varies. The screen 51 is provided with a diffusion pattern composed of a series of concentric areas 52-57. The density of the diffusion pattern is highest in the outer area 52, gradually decreases over the areas 53-56 and is lowest in the central area 57. Alternatively, it can also be said that the spacing in between the diffusing elements varies and is largest in the central area 57, decreases over the areas 56-53 and is smallest in the outer area 52. The screen 51 of FIG. 15 is a “converging” optical element as defined herein, with an increasing density from centre to outer rim. Alternatively, screens may also be used which have a “diverging” pattern or a pattern which varies in other ways, depending on the application. In the screen 51, the areas 52-57 are bordered by concentric circles, but other shapes may also be used such as ovals, squares etc. The density may also vary continuously instead of stepwise as shown. Tests have shown that a particularly advantageous embodiment of the invention is found in the combination of a “diverging” screen in front of the image and a “converging” screen in front of the “diverging” screen. This combination operates analogously to a collimating lens, but with the advantage that the image can be viewed from different distances and angles without losing the depth effect.

Surprisingly, by means of the screens, glasses, foil and television screen of FIGS. 9-14, not only a depth perception stimulating factor is generated into the image shown, but also a sharpening factor. More particularly, tests have shown that the images which are viewed by means of these devices are also perceived sharper than when viewing them without these devices. In other words, contrary to what would be expected, by adding the diffusion to the original image its overall perceived quality can be improved and the devices of FIGS. 9-14 can also be used for obtaining a sharper view of blurry images, i.e. images which are not fully in focus. This is clarified by the fact that the diffusion which is applied over the original image leads to a multitude of light beams in multiple directions, which by interference amongst others includes a recombination of the original image. By interpretation in the human brain, this recombination image can be filtered out of the whole of visual information captured by the eyes, so that the total image can be perceived as being sharpened by means of the screens of FIGS. 9-15.

The effect of interference and recombination which occurs can be compared to the effect of an “aural exciter” in audio applications, which artificially generates harmonics by partially distorting the signal. Likewise, objective measurements do not show an improvement of audio quality, but a serious improvement is heard, i.e. the effect is psychological. Therefore, the optics and algorithms of the invention could be considered as “optical exciters”.

In the above, the method of the invention is mainly applied to the displaying stage of an image. The method of the invention can however also be applied already at the recording stage or in between, in a processing stage. This is clarified by means of FIG. 8, which schematically illustrates the different stages where the method of the invention can be applied, for finally generating planar visual information which is interpreted as three-dimensional. The stages are denoted by the letters A, B and C. Stage A is the capturing or recording of the image. Indeed, according to the invention the diffused image for stimulating human depth perception can already be added to the image 29 which is captured by means of devices 30 for recording visual information. Stage B is the processing stage, i.e. between capturing and reproducing the image, and comprises image processing techniques in computers 31, copying of films, conversion of video and the like. Stage C is the displaying or reproduction stage, i.e. when the image is shown on a television screen 32 or projected onto a screen by means of a projector and actually supplied to the human eye 33. Of course, the method of the invention can be applied on two or more stages simultaneously, for enhancing the achievable depth effect.

FIGS. 4-7 show a number of applications of the method of the invention. In FIGS. 4 and 5, the method of the invention is applied in stage A, i.e. for recording visual information which upon display is provided for being perceived as three dimensional.

In FIG. 4, transparent screens 6, 9 with diffusion pattern are placed between the objects 5 to be recorded and the image capturing device 11 (e.g. CCD or other) of a camera 10. In the embodiment of FIG. 4, the camera 10 is provided with a first screen 6 in front of its first lens 7 and a second screen 9 between its second lens 7 and the image capturing device 11. However, other configurations of the optical elements 6-9 of the camera 10 are also possible. The screens 6, 9 can be provided with any of the diffusion patterns as described with reference to the FIGS. 9-15. Furthermore, the lenses 7, 8 of the camera may also be provided with a diffusion pattern on the surface and/or within the lens material.

In FIG. 5, the image of the objects 12 which is captured by the camera lens 13 is split by means of a mirror 14 with (for example) 50% transparency into a first image, which is recorded on a first image capturing device 15, and a second image, which is passed through a diffusing filter 16 and then recorded on a second image capturing device 17. The first image, which represents the original image, and the second image, which represents the diffused image generated from the original image, are fused by means of an adder 19. The amount of diffused image added to the original image can be controlled by means of a controller 18.

The image recording method of FIG. 5 may also be achieved in fully electronic form (not shown), with a digital recording camera which is provided with electronic circuitry for adding a diffused image to the original image (not shown). In such embodiment, the electronic reproduction of the original image is copied to a side-track, where the copy is diffused to a predetermined extent (for example by means of the method of FIG. 16 or 17). Finally the diffused copy is added back to the original, for example by taking a weighted average of the two. This also has the advantage that the extent of diffusion can be varied over the image, depending on its content, i.e. depending on depth information which is captured by means of a second camera.

In FIG. 6, the method of the invention is applied in stage C, namely to projection of images on a reflective screen, such as for example a movie theatre screen 24. In order to achieve the desired depth effect in the projected image, one or more transparent screens with diffusion pattern 22, 23 are placed in between the lens 21 of the projector 20 and the reflective screen 24. Optionally, the projector lens 21 may also be provided with a diffusion pattern on its surface or integrated into the lens material and the reflective screen 24 may also be provided with a means for partly diffusing the image projected onto it. Such a means may for example be formed by a pattern of surface irregularities or other means. Optionally, further diffusion screens (not shown) may also be provided between the viewer and the reflective screen 24. For example in movie theatres, diffusion screens be built into the seats, so that each viewer is provided with a diffusion screen directly in front of him.

In FIG. 7, the method of the invention is applied in stage B, namely for converting a regular film 26 into a modified film 28, which is provided for being perceived as three dimensional. In the film conversion method of FIG. 7, the regular film 26 is irradiated with light from a light source 25. The image thus created is passed through conversion optics 27, which may be formed by various optical elements such as screens, lenses, filters or other optical elements, of which at least some are provided with the diffusion pattern of the invention. The modified image 27 generated by the conversion optics 27 is then re-recorded onto a film 28. This method can for example be applied by simply showing the regular film on a television screen or projection screen and recording the regular the screen by means of a camera fitted with conversion optics, such as for example the camera of FIG. 4 or 5.

In FIGS. 16 and 17, the method of the invention is also applied in stage B, namely in the form of processing the original image in digital form to a modified image comprising the depth perception stimulating factor.

In the algorithm of FIG. 16, the original image is processed as follows. First, the original image is conveniently split into the three sub-images in the primary colours red, green and blue. Next, the red image is shifted one pixel to the right and the green image is shifted one pixel to the left. The blue image is left in its original position. Finally, the red, green and blue images are fused to a modified image, which is exported. The shift over one pixel is a small modification to the original image, which remains substantially unnoticed or subliminal to the viewer of the modified image. In fact, the modified image still comprises the original image, along with a diffused image generated over the original image.

The algorithm of FIG. 16 can be varied in many ways. For example, the sub-images which are shifted or not can be varied. The shifting distance can be more than one pixel. Furthermore, the shifting distance can also be varied for each pixel, for example randomly selected from a predetermined distance range.

The algorithm of FIG. 17 is an alternative processing method for converting a digital original image to a digital modified image which has the desired depth perception stimulating factor. By to the algorithm of FIG. 17, each pixel xᵢⱼ(R, G, B) is replaced by a pixel xᵢⱼ′(R, G, B), the values R, G and B being the intensity of the colour dots Red, Green and Blue which compose the pixel. The replacing pixel xᵢⱼ′(R, G, B) is the weighted average of the original pixel xᵢⱼ(R, G, B) and a weighted sum yᵢⱼ of the surrounding pixels, i.e.:

xᵢⱼ(R,G,B) [symbol] xᵢⱼ′(R,G,B)

with

xᵢⱼ′=(1−α)xᵢⱼ+αyᵢⱼ

and

yᵢⱼ=β_{i-1,j-1}x_{i-1,j-1}+β_{i,j-1}x_{i,j-1}+β_{i+1,j-1}x_{i+1,j-1}+β_{i-1,j}x_{i-1,j}+β_{i+1,j}x_{i+1,j}+β_{i-1,j+1}x_{i-1,j+1}+β_{i,j+1}x_{i,j+1}+β_{i+1,j+1}x_{i+1,j+1}

The coefficient α is a predetermined diffusion coefficient, which is chosen for adding a subliminal amount of depth perception stimulation to the image. This diffusion coefficient α can be a constant, i.e. the same amount of depth perception stimulation is added to each pixel or over the whole image, or the diffusion coefficient α can be a variable, for example derived for each pixel from depth information which is captured during recording of the image or calculated for each pixel as a function of the estimated position of the object shown in the image. The latter is for example applicable for adding depth to a cartoon image. The diffusion coefficient α can also be varied in order to simulate the effect of a “converging” or “diverging” optical element, or a combination thereof, as has been described above.

The weight coefficients βᵢⱼ of the weighted sum yᵢⱼ can be random coefficients or, more preferably, predetermined coefficients stored in a convolution matrix β. This convolution matrix β can for example be generated from depth information captured during recording of the image or by calculation. One way of calculating the convolution matrix β is to compare the adjacent pixels and measure the difference between each pixel and its surroundings. In case of a low difference, a negative coefficient βᵢⱼ whose magnitude is proportional to the difference is placed in the matrix β; in the other cases a positive coefficient βᵢⱼ is placed in the matrix β. The resulting weight coefficients βᵢⱼ can thus be negative, which in fact leads to a local sharpening of the image, positive, which in fact leads to a local blurring or diffusion of the image, or zero, where the image is to remain untouched.

Because the algorithm of FIG. 17 can also be used to sharpen images, it can also be adapted to convert standard TV images to HDTV images of higher resolution. The adaptation will be to stretch the original standard TV image to the HDTV image by spreading the pixels and to “fill the gaps” with pixels calculated by means of the algorithm of FIG. 17. In this way, a sharp and three dimensionally perceived HDTV image can be generated from a standard TV image. This particular embodiment of the invention seems very interesting, since it enables HDTV broadcasting with the same bandwidth as standard TV: one can simply broadcast standard TV images which will be converted in the HDTV set to HDTV images.

In FIG. 18, another embodiment of the invention is illustrated. In this embodiment, a viewer uses two optical elements 47 and 48 for viewing a planar image on a screen 46. The optical elements 47 and 48 are both screens like the sequence of screens 43-45 shown in FIG. 14. In FIG. 18 however, the viewer uses one element 47 in front of his left eye 49 and the other 48 in front of his right eye 50. The element 47 in front of the left eye 49 is rotated 45° to the left and the element 48 in front of the right eye 50 is rotated 45° to the right. Due to the refractive index of the material of the optical elements the image, the images viewed through the elements 47, 48 are shifted apart. This, in combination with the diffused image which is again added by the optical elements 47, 48, leads to an enhanced depth effect. Optionally, the elements 47, 48 can be rotatable, so that the viewer can optimise their positions to what he feels is best.

From the above, it has become clear that the invention can be applied to different stages of imaging techniques and to a wide variety of fields. In general, the invention can be applied without limitation to the following fields:
still images in general: photographic images, drawings, paintings, etc.;
moving images in general: television, film, video, video games, etc.;
visualisation systems for use in or during surgery or other visualisation systems for inspecting the human or animal body;
webcams, video chat systems, etc;
glasses, contact lenses or other visual aids for correcting human eyesight;
video-effect apparatuses and software;
filters for placement on lenses;
LED's on video-walls (lens+3D foil)
3D television: TV sets, camera's, image conversion devices and software;
any other field involving planar images.

1-26. (canceled)

27. A method for generating a planar image which is provided for being perceived by humans as three dimensional, the method comprising the step of generating at least two overlapping portions of planar visual information which are provided for being simultaneously supplied to a human brain via at least one eye, wherein a first portion of the planar visual information comprises an original planar image and a second portion of the planar visual information comprises a diffused image which is generated from the original image by diffusion to a predetermined extent, chosen for stimulating human depth perception.

28. A method according to claim 27, wherein the diffusion extent is subliminal.

29. A method according to claim 27, wherein the diffused image is generated by means of one or more transparent optical elements having a predetermined diffusion pattern of parts with different refractive indices.

30. A method according to claim 27, wherein the diffused image is generated by means of a sequence of transparent optical elements with partial reflectivity.

31. A method according to claim 27, wherein the method further comprises the step of mixing the first and second portions of planar visual information into a modified planar image.

32. A method according to claim 31, wherein the modified planar image is generated by means of the following steps:
(a) splitting the original planar image by colour division into at least two sub-images,
(b) applying a predetermined modification to at least one sub-image, and
(c) reuniting the sub-images to the modified planar image, the predetermined modification being chosen such that it generates the diffused image into the modified planar image.

33. A method according to claim 32, wherein the original planar image is split into three sub-images, each being in one of three primary colours and that the predetermined modification comprises shifting one sub-image over a predetermined distance in one direction and shifting another sub-image over this predetermined distance in the opposite direction.

34. A method according to claim 32, wherein the original planar image is split into three sub-images, each being in one of three primary colours and comprising a plurality of pixels and that the predetermined modification comprises shifting each pixel of one sub-image over a random distance within a predetermined range in one direction and shifting each pixel of another sub-image over a random distance within the predetermined range in the opposite direction.

35. A method according to claim 31, wherein the original planar image comprises a plurality of pixels and that the modified planar image is generated by means of the following steps:
d) for each pixel, calculating a weighted sum of the pixels surrounding that particular pixel, using predetermined weight coefficients,
e) calculating a weighted average from the pixel and the weighted sum, using a predetermined diffusion coefficient, and
f) replacing the pixel by the weighted average.

36. A method according to claim 35, wherein the predetermined weight coefficients and/or the predetermined diffusion coefficient is/are selected according to depth information associated with the original planar image.

37. A method according to claim 35, wherein steps d) to f) are repeated at least once for generating a second modified planar image.

38. A method according to claim 27, wherein the method further comprises the step of controlling the extent of diffusion towards an optimum stimulation of human depth perception.

39. A method according to claim 27, wherein the at least two overlapping portions of visual information comprise a left eye image provided for being viewed by means of the left eye only and a right eye image provided for being viewed by means of the right eye only, the left and right eye images being generated for triggering binocular stereoscopy.

40. A method according to claim 27, further comprising the step of broadcasting the visual information over a television distribution network.

41. A method according to claim 27, further comprising the step of recording the planar image which is provided for being perceived by humans as three dimensional.

42. A method according to claim 27, further comprising the step of converting an original planar image to a modified planar image, said modified planar image being said planar image which is provided for being perceived by humans as three dimensional.

43. An algorithm for implementing the method of claim 32, stored on a data carrier in a computer readable form.

44. An optical element for generating a planar image which is perceived by humans as three dimensional, the optical element being partly transparent for passing an original planar image, wherein the optical element has a predetermined diffusion pattern for generating a diffused image from the original planar image, the predetermined diffusion pattern being chosen for stimulating human depth perception.

45. An optical element according to claim 44, wherein the diffusion pattern comprises a plurality of substantially parallel lines of a predetermined width and spaced at predetermined regular distances.

46. An optical element according to claim 44, wherein the diffusion pattern comprises a random pattern of dots of a predetermined maximum size, the pattern having a predetermined dot density.

47. An optical element according to claim 44, wherein the optical element is a stick-on foil.

48. A pair of glasses, at least one of which is an optical element according to claim 44.

49. A sequence of optical elements for generating a planar image which is perceived by humans as three dimensional, wherein each of the optical elements is partly transparent for passing an original image and partly reflective for reflecting the original image and generating a diffused image of the original image for stimulating human depth perception.

50. A visual information recording device which is equipped with one or more optical elements according to claim 44.

51. A visual information recording device which is equipped with electronics for performing the method of claim 32.

52. A visual information displaying device which is equipped with one or more optical elements according to claim 44.

53. A visual information recording device which is equipped with a sequence of optical elements according to claim 49.

54. A visual information displaying device which is equipped with a sequence of optical elements according to claim 49.
